(19) United States
(12) Patent Application Publication
(10) Pub. No.: US 2015/0213035 A1
(43) Pub. Date: Jul. 30, 2015

(54) Search Engine System and Method for a Utility Interface Platform

(71) Applicant: Bit Stew Systems Inc., Burnaby (CA)

(72) Inventors: Kevin Collins, Maple Ridge (CA); Alexander Franklin Clark, Vancouver (BC); Kevin Smith, Port Moody (CA); Volodymyr Gukov, Richmond (CA); Andy Cheng, Aurora, CO (US)

(21) Appl. No.: 14/258,581

(22) Filed: Apr. 22, 2014

Related U.S. Application Data
(60) Provisional application No. 61/931,554, filed on Jan. 24, 2014.

(51) Int. Cl. G06F 17/30

(52) U.S. Cl. CPC G06F 17/3087; G06F 17/30595

(57) ABSTRACT

Modern utilities are increasingly installing smart meters, which can typically generate hundreds of millions of data points daily. Such a massive volume of data is unwieldy to manage with the databases in current utility interface platforms. A solution converts the data to canonical documents and indexes some or all the data points such that a freeform search engine can be used to search for and access the data, resulting in a much more convenient and faster retrieval of data.

This application claims the benefit of U.S. provisional patent application Ser. No. 61/931,554, filed on Jan. 24, 2014, which is incorporated by reference herein in its entirety.

### TECHNICAL FIELD

This application relates to interfacing with utility supply systems. More specifically, it relates to a method and system for organizing, searching and accessing data created by multiple disparate data sources within a utility supply system.

### BACKGROUND

In the electricity supply industry, a typical advanced metering infrastructure (AMI) network may comprise millions of smart meters, each containing multiple hardware and software elements, sending hundreds of millions of data points per day through a variety of communications networks to an array of back-office systems. Simply keeping a machine-to-machine network like this in day-to-day working order is a hefty task, perhaps the biggest yet in the nascent field of the “internet of things.” Smart-meter-equipped utilities are faced with an even bigger challenge: integrating that machine-to-machine network into an entire enterprise worth of IT systems, and making the entire mash-up usable and comprehensible to the people who run it, without overwhelming them.

As the applications for smart devices multiply, the need to manage the data they relay and help those devices talk to each other grows. There is an increasing need for continuous data integration at high speed. Grid modernization adds complexity to the technology landscape with head-end control applications, telecom, and intelligent devices, which all create a further challenge. Utility operations need to deal with the increasing importance of cyber security, which is heightened by the increased intelligence of the supply grids, their interconnected systems and their devices collectively presenting new threat vectors to the utility.

The current, significant challenges to operate efficiently and effectively at scale as utilities modernize their grids include: an increase in the number of interdependent systems including multiple control systems; orders of magnitude decrease in data latency and response time; an increase in the variations and complexity of the data; increased security risks and concerns with connected devices; grid vendors provide limited visibility into the field and edge devices; a lack of operations tools to manage and visualize all networks and devices; a dependence on internally developed tools and disparate point solutions; a lack of tools to manage asset lifecycles exacerbated with the increase in intelligent devices at the edge; less than optimal decisions as a result of poor overall visibility; and difficult and expensive integration, support and maintenance.

Currently, the majority of utilities with AMI networks are managing at least two different communication infrastructures. The majority of utilities say current solutions do not provide useful intelligence of the network and are concerned about getting meaningful and useful data in their operations. Furthermore, the majority of utilities are concerned about integrating solutions from multiple vendors.

While there are many aspects of a utility interface platform (UIP), an important aspect in modern day utilities is to provide access to the mass of data produced by the various connected devices and systems, particularly, but not exclusively, smart meters. Without any dedicated means for this, users or utility network operators need to extract operational data from the AMI vendor head-end system, load it into a database, and run spreadsheets on it the day after. Instead, data access can be provided by the prior art system 10 as shown in FIG. 1. In system 10, multiple different source systems 12 forming part of the overall utility system create data in different formats. This data is extracted in batches 14 and, using complex and time-consuming Extract, Transform and Load (ETL) procedures 16, the data is stored in databases 18 in large data warehouses 20, which are typically external from the utility. The data warehouses are often implemented using relational, graph, tabular or object databases such as Cassandra™ MongoDB™, Oracle™ Postgres™, MySQL™ and MSSQL™. The data is then extracted over a network 22 using a protocol such as JDBC, ODBC, TCP, UDP or HTTP(S). Analytics applications resident in a terminal computer 24 extract the data from the data warehouse 20 for presentation to and action on by an end user 26, such as a utility network operator. If the users require information from the database warehouse that is not provided by the analytics applications, then they need to find another application or write a database query using the proper syntax, which can be time-consuming and/or difficult, especially for those without knowledge of writing database queries.

When searching such large databases, the search time may be long and may consume excessive processing power. Missing indices can be crippling, and indices do not allow for ad hoc queries. Indexing billions of data records in a database does not perform well in practice. Significant operational problems can occur with ETL systems. For example, the scope of data in a source system may grow beyond the expectations of designers at the time the transformation rules are specified. The ETL system may therefore need to be revised every time the source systems are developed, and modifying schemas can be costly.

Other limitations of an RDBMS (relational database management system), in particular, is that it is often bound to a single server and disk, is heavily 10 (input-output) bound, has a threaded SQL (structured query language) execution model (i.e. one query=one CPU), and is based more on closed standards than open ones (JDBC vs HTTP).

If data extraction batches 14 are run daily, the data available to the user will rarely be as up-to-date as it could be. This will be true, but to a lesser extent, if the batches are run several times per day.

This background information is provided to reveal information believed by the applicant to be of possible relevance to the present invention. No admission is necessarily intended, nor should be construed, that any of the preceding information constitutes prior art against the present invention, except for the above description of the prior art system 10 in FIG. 1.

### SUMMARY OF INVENTION

The present invention is directed to a search engine system (SES) and method for organizing, searching and accessing data created by multiple disparate data sources within a utility supply system. With vast amounts of data in transit and at rest, the modern utility operator needs a simple, capable and reliable source of truth.

Disclosed herein is a processor-implemented method for searching for data generated by multiple source systems in a utility, comprising: receiving, by the processor, a freeform search term; searching, by the processor, for one or more elements of the term in an index; locating, by the processor, one or more entries in the index that correspond to the one or more elements; and retrieving, by the processor, one or more canonical documents that correspond to the located one or more entries, wherein the canonical documents comprise the data generated by the multiple source systems in the utility, and wherein the data generated by the multiple source systems is generated in different formats.

Also disclosed herein is system for searching for data generated by multiple source systems in a utility, the system comprising: a processor and; one or more computer readable media storing: an index of at least some of the data in a set of canonical documents, wherein the canonical documents comprise the data generated by the multiple source systems in the utility, and wherein the data generated by the multiple source systems is in different formats; and a search engine that, when executed by the processor, receives a freeform search term and uses one or more elements of said term to locate one or more entries in the index corresponding to said one or more elements.

Further disclosed herein is a computer readable media product comprising computer readable instructions, which, when executed by a processor, cause the processor to: store an index of data in a set of canonical documents, wherein the canonical documents comprise data generated by multiple source systems in a utility, and wherein the data generated by the multiple source systems is in different formats; and receive a freeform search term; and use one or more elements of said term to locate one or more entries in the index corresponding to said one or more elements.

### BRIEF DESCRIPTION OF DRAWINGS

Some of the following drawings illustrate embodiments of the invention, which should not be construed as restricting the scope of the invention in any way.

FIG. 1 is a schematic diagram showing a prior art system for storing data from multiple source systems in a data warehouse, where the data is processed using an ETL method.

FIG. 2 is a schematic overview of an embodiment of a search engine system (SES) in accordance with the present invention, in which data is extracted in near real time from multiple source systems and stored in a search engine.

FIG. 3 is a schematic diagram of the main modules in an embodiment of the SES of the present invention.

FIG. 4 is a schematic overview of the main architectural modules of a utility interface platform in which the present SES may be incorporated.

FIG. 5 is a flowchart for the retrieval, storage and indexing of data generated by source systems.

FIG. 6 is a flowchart for searching for data generated by source systems.

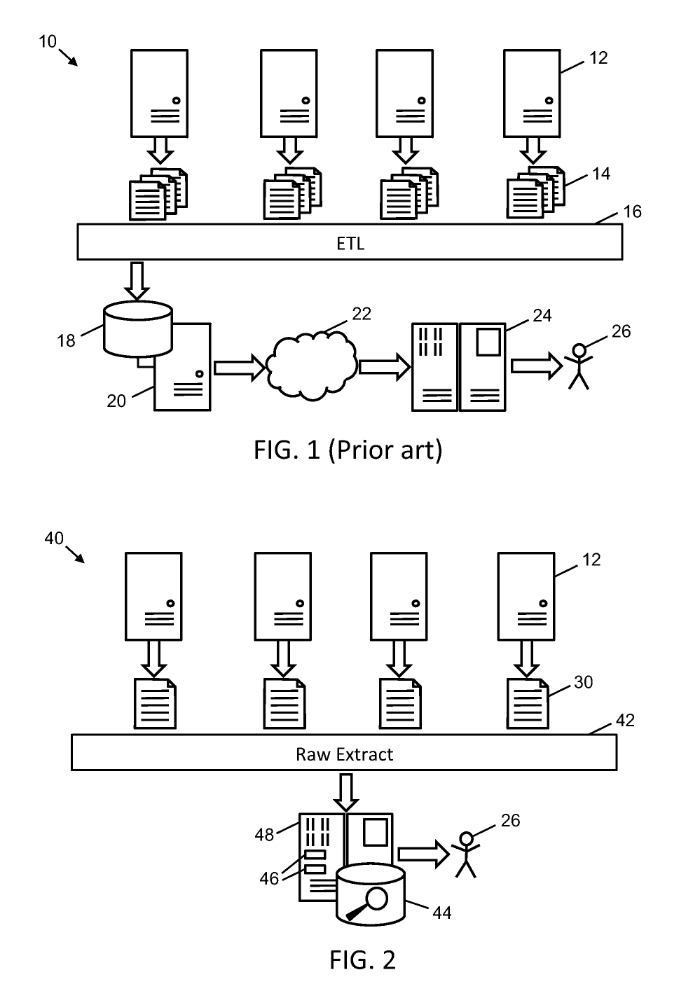

### DETAILED DESCRIPTION

### A. Glossary

AMI—Advanced metering infrastructure. Typically a network of smart meters.

Canonical documents—These are documents containing the data extracted from the different source systems. The document format is a common data model that is independent of the format of the source data.

ETL—Extract, transform and load. This refers to the procedure of extracting data from multiple sources, with different data formats, and parsing it to check that the data meets an expected pattern or structure. The data is then transformed into a desired format, by, for example, selecting various parts, performing calculations on it, aggregating it, etc. Finally, the data in the desired format is loaded into one or more databases in a data warehouse.

Head-end device—A device that connects to the periphery of the utility network, such as a smart meter. Also included could be an electric vehicle or solar power generator that consumers connect to the utility network to sell electricity to it.

IEC CIM—International Electrotechnical Commission Common Information Model. This is a standard format for the exchange of data between different software applications within an electrical network.

The term “network” can include both a mobile network and data network without limiting the term's meaning, and includes, for example, the use of wireless (2G, 3G, 4G/LTE, WiFi, WiMAX, BGAN/CBAND, Ethernet, Wireless USB, Zigbee, Bluetooth, proprietary RF and satellite), and/or hard wired connections such as internet, ADSL, DSL, cable modem, T1, T3, fiber, dial-up modem serial connections, mesh networks and may include connections to point-to-point solutions, to programmable logic controllers, and to flash memory data cards and/or USB memory sticks where appropriate. A network may utilize protocols such as DNP3, C12.22, MODBUS, 6LoWPAN, EAP-TLS, SSL/IPSEC, HTTP/CoAP, SOAP/REST, MQTT, IEEE 802.14.5G, ITU G.HN, IEEE 802.15.4 2.4 GHz, IEEE P1901-2, IPv4 and IPv6, for example. Additional layers and connector types such as IEC61850, C12.19, OPC and others may be involved. A network could also mean dedicated connections between computing devices and electronic components, such as buses for intra-chip communications.

Operational Technology (OT)—The technology used in operating a utility, particularly the hardware. This term is to be distinguished from IT (Information Technology), which is mainly software based technology.

The term “processor” is used to refer to any electronic circuit or group of circuits, including integrated circuits, that perform calculations, and may include, for example, single or multicore processors, an ASIC, and dedicated circuits implemented, for example, on a reconfigurable device such as an FPGA.

The term “server” is used to refer to any computing device, or group of devices, that provide the modules and/or functions described herein as being provided by one or more servers.

SES—The search engine system of the present invention, including source systems, data adapters, an indexer and a search engine.

Source of truth—Since some or all of the same data can be stored, replicated and/or updated in multiple locations at different times, it can be difficult to keep track of which source to use and how to access it, and to know whether the data is the correct version. It is much simpler to retrieve data from a single location that is designated as the source of truth.

Source system—A device or system that is connected to the utility network and generates data. Examples of source systems include AMI head-ends, distribution head-ends, automation head-ends, supervisory control and data acquisition (SCADA) systems, IPv6/4 network management systems, device network management systems, substation controllers, proprietary gateways and security systems.

Utility—An entity, for example an enterprise and its infrastructure, that provides one or more of electricity, natural gas, town gas, water, waste disposal, bandwidth, etc. to residential and/or industrial consumers.

Utility interface platform (UIP)—A computer and network based system that interacts with some or all of the constituent systems of a utility. Examples of constituent systems are a transformer network and smart meter network.

XML—Extensible markup language

All of the methods and processes described herein may be embodied in, and fully automated via, software code modules executed by one or more computing devices. The code modules may be stored in any type(s) of computer-readable media or other computer storage system or device (e.g., hard disk drives, solid-state memories, etc.). The methods may alternatively be embodied partly or wholly in specialized computer hardware, such as ASIC or FPGA circuitry. The results of the disclosed methods and tasks may be persistently stored by transforming physical storage devices, such as solid-state memory chips and/or magnetic disks, into a different state.

In general, unless otherwise indicated, singular elements may be in the plural and vice versa with no loss of generality. The use of the masculine can refer to masculine, feminine or both.

The descriptions that follow are presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated by one or more processors, each with one or more cores. It will be further appreciated that the line between hardware and software is not always sharp, it being understood by those skilled in the art that the software implemented processes described herein may be embodied in hardware, firmware, software, or any combination thereof. Such processes may be controlled by coded instructions such as in microcode and/or in stored programming instructions readable by a computer or processor. Furthermore, the processes may be divided into constituent modules or components.

### B. Overview

FIG. 2 is a schematic diagram of an overview of an embodiment of the SES 40 in accordance with the present invention, in which data is extracted in real time or near real time from multiple source systems and stored in real time or near real time in a search engine. The search engine may be embedded in a UIP, which may be installed in the utility or accessed via SaaS (Software as a Service) in the cloud. The SES 40 in the overview includes multiple source systems 12. Data 12 is pushed from the source systems 30 as and when it is generated, or it is pulled on demand. The SES 40 therefore effectively extracts, or is capable of extracting, the data in real time or in as near real time as possible taking into account the physical constraints of the various components of the SES 40. The raw extract 42 of data is then passed to various internal modules for analysis and adaptation into documents. Depending on the embodiment, every part of the data is indexed or just some of the data is indexed. The index 44 and documents 46 are made accessible to an internal search engine 48. The SES 40 uses a common representation of all data, or business information, that is exchanged within the utility, which is one of the most important aspects of a scalable solution. Data modeling is abstracted away from technology and specific implementations, allowing a UIP to access consistent and common information regardless of location, purpose, design, and development. This is one of the key aspects to adopting a loosely coupled architecture, and gives the utility visibility into essential data and/or business information that is collected and exchanged.

Instead of traditional external databases that warehouse the data, an internal search engine is used such as Apache Lucene™ in order to fulfill an Elasticsearch™ query or other freeform query entered by the user 26. One of the main benefits of this SES 40 is that the search terms can be freeform, rather than having to be structured as in traditional database searches or queries.

The SES 40 offers scalability and high performance across massive data sets. It has been scaled to over 1 billion end points with all data fully indexed and searchable. It is important to note that all data can be indexed, and in some embodiments it is all indexed, and therefore fast retrieval based on any number of attributes is achieved. This offers near real-time searching and analysis of data at-rest.

The indexing system also allows for complex searches to be performed, along with instant analysis, correlation and aggregation of the result sets. Performance with hundreds of millions and billions of data elements is counted in just a few milliseconds and this can easily be scaled for extreme cases.

### C. Exemplary Embodiment

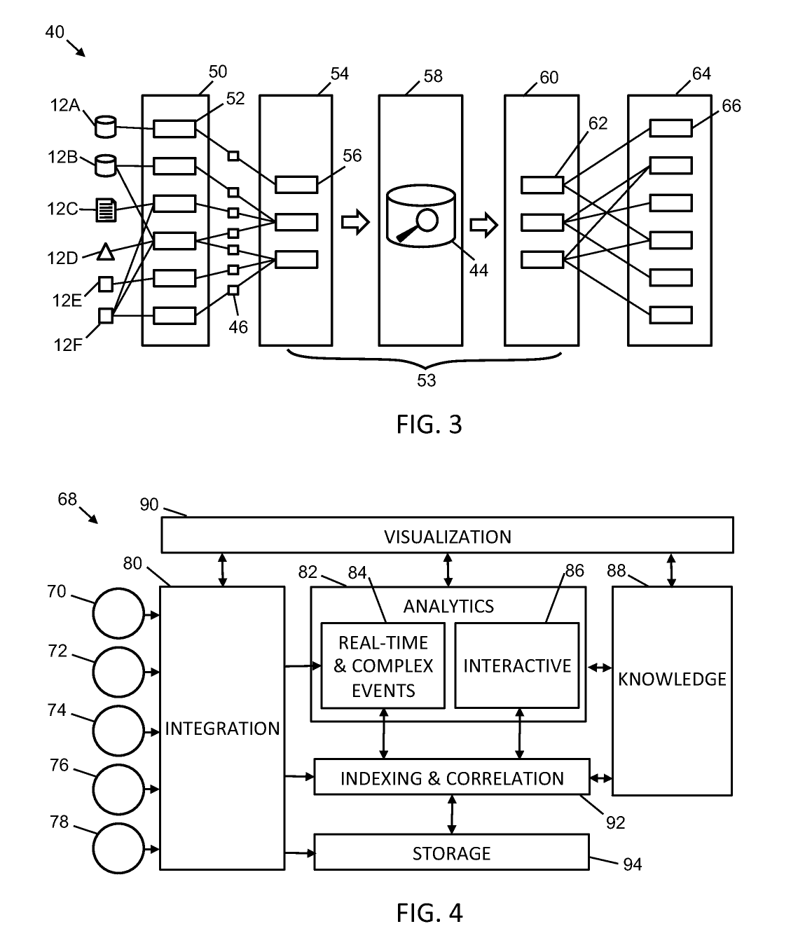

FIG. 3 is a schematic diagram of the main modules in an exemplary embodiment of the SES 40 of the present invention.

Disparate source systems 12A-F are shown as providing inputs to the SES 40. A source system can be any system that creates data, and examples of such are depicted here to be an RDBMS 12A, a NoSQL database 12B, documents 12C, an application 12D, a Rich Site Summary (RSS) feed 12E and router 12F.

Data can be retrieved from any number of utility OT and IT systems, databases and files using the built-in integration adapters. This includes obtaining information direct from database sources as well as through data connectors, files, application APIs and web services.

The inputs from the source systems 12A-F are received by canonical mapping module 50 of the SES 40. Data received is mapped by a series of adapters 52 in the canonical mapping module 50. Data from all the sources is converted into canonical documents. Fields in the records of the source data are converted to elements within the canonical documents. Canonical documents 46 of the SES 40 are used to ensure the success of integration between a UIP and the constituent utility OT/IT systems. The documents may be based, for example, on the IEC CIM standards for representation of information and may utilize this throughout for analytics, rules processing and other business logic. The IEC CIM standards have been developed specifically for the electricity distribution grid, although different standards could be used for the distribution grids or for other types of utility. Once the data models are defined, for example as XML schemas, the implementation of the SES 40 requires developing a set of adapters that can map the utility data to the internal CIM-based data models used by the SES 40. Although IEC CIM is an industry standard, the actual model used has been extended significantly to accommodate the diverse requirements of retrieving data from the source systems 12 within the utility.

Data retrieval can be a synchronous and/or asynchronous communication pattern with a preference for asynchronous. Data may be aggregated, correlated and decorated with missing information across source systems 12A-F. An adapter 52 can create one or more canonical documents from a given data record, and one or more types of canonical document.

Adapters 52 include templates designed to map data from source systems 12 to canonical documents 46 based on an extension of the IEC CIM. Adapters 52 are hosted separately to provide a layer of separation from the core services 53 of the SES 40, which comprise the document handling module 54, the data indexing module 58 and the canonical service module 60. This allows for improved security, performance scaling, and separation between code bases. Adapters 52 cannot directly change stored data or indexed data, which instead is done by the core services 53. Adapters 52 send document messages to the core service and do not call a function to perform the same actions. This guarantees separation through a services layer and avoids back-door implementations.

The canonical documents 46 are then passed to a document handling module 54 comprising multiple document handlers 56, which index the documents and/or data within them using an algorithm 57 in the data indexing module 58. Indexing is critical and is asynchronous. It is possible to index out of order and the SES 40 should support conflict resolution. All sources of information may be indexed, as well as the type of information and the cross reference details such as keys and IDs.

The index 44 resides in the data indexing module 58. The technology underlying the indexing solution is a NoSQL solution based on a map-reduce architecture that offers performance, scalability and distribution of I/O load. In a UIP, the indexing system would be embedded within the core services 53 and therefore be accessible to all UIP applications and components and all instances of the UIP can share in the scale and distribution of the indexer nodes. The indexing architecture is natively based on distribution and redundancy with multiple indexer nodes spread across different instances. This improves I/O capacity while also ensuring maximum up-time. If one node fails, other nodes can take up the slack and all data is automatically replicated.

The advantages of NoSQL compared to RDBMS are: it models data as complete and self-contained documents (mostly); it has a more flexible query language; it can span queries across many nodes (massively parallel processing); everything is indexed; it has strong support for ad-hoc and natural language queries; it supports many query types including “fuzzy”; document sets into the billions are not uncommon; and extremely fast searches. For example, NoSQL indexes 10 million records in less than 2% of the time required by RDBMS. It can also query 24 billion records in 900 milliseconds, whereas RDBMS would be challenged to even process this volume of data.

The documents are stored in the document handling module 54, however, storage of the documents in the SES 40 itself may or may not be required depending on the architecture of the UIP. Wherever they are implemented, storage systems should remain abstracted to provide scale, redundancy and performance.

Canonical XML services module 60 has multiple services 62 which provide common access to information indexed in the SES 40. An example of a service module 60 would be a high performance search engine with support for faceted searches. Output of data from the core services 53 is in canonical form. The XML services 62 present standard outputs to whatever is used for presentation or processing. The XML services do not assume what will consume the information. The XML services do not assume that the data comes from a relational database or even a single data source.

The presentation module 64 of the SES 40 contains presentation components 66 for displaying retrieved data to users of the SES. Indicators or other presentation components 66 should retrieve information from common services 62 rather than using a dedicated XML service, to promote re-use and consistency.

The SES 40 provides the ability to search for any type of data regardless of location and type based on a flexible set of criteria established by customers.

FIG. 4 is a schematic overview of the main architectural modules of a UIP 68 in which the present SES 40 may be incorporated. The UIP architecture includes four main architectural frameworks that define and enable application functionality such as integration and visualization. The frameworks come with standard XML data structures and APIs (Application Programming Interfaces) that are leveraged by the UIP 68 and third party developers. In addition to the frameworks, the UIP 68 includes the core data model, data handlers and the powerful indexing sub-system.

The types of input 70-78 to the UIP 68 include one or more of reads, events, customers, work orders, locations, grid/enterprise data, grid/enterprise models, grid connectivity, market information, census and third party information. Such information may be generated by one or more of the source systems 12, 12A-F. In other embodiments, the information may be provided from a source within the UIP 68.

The integration framework 80 of the UIP 68 is responsible for direct integration with utility OT and IT systems and provides data mapping, canonical preprocessing, out-of-the-box adapters, protocol adapters and protocol translation for major head-ends, network systems and applications. The integration framework 80 may include canonical mapping module 50, for example. The integration framework 80 provides access to enterprise source systems, message routing with prioritization and quality control, and seamless synchronous and asynchronous web services.

The analytics framework 82 of the UIP 68 supports a high-performance module 84 for real-time analysis of the data stream with validation and filtering, as well as complex event processing. In-memory capabilities allow for fast analysis and near real-time decisions. The analytic framework also includes an interactive module 86 with a set of business rules and algorithms for information processing of the data streams as well as data at-rest, and is useful for analyzing dynamic changes and for providing predictive logic. It provides network metrics, trending and statistical analysis, and event correlation across the utility's network. The analytics framework may include canonical services module 60, for example.

The knowledge framework 88 is a unique aspect of the UIP 68, and includes business rules, schemas, a data dictionary, templates, patterns, classifications, normalizations, metrics, facts, thresholds, records, tags, meta-data and other informational components that are utilized in the UIP's processing. It can provide intelligent monitoring and alerting.

The visualization framework 90 of the UIP 68 may include presentation module 64 and provides a unique set of intuitive visual elements including detailed packaging and structuring of information for visual presentation, including context, network situational awareness, dynamic views and aspects. Real-time maps, charts, data grids, tables and panels can be displayed. The framework supports a number of third party presentation elements including charting/graphing from FusionCharts™, Google™, and HighCharts™. Control and management of the visualization framework 98 is role based. It also has plug-in capabilities.

Underlying the main framework elements 80, 82, 88, 90 is an embedded technology for information indexing and search 92. This indexing technology 92 is federated and standardized, and is based on NoSQL and map-reduce data structures that support a high-degree of distribution and redundancy. It may include document handling module 54 and data indexing module 58, for example.

Connected to the integration framework 80 and the indexing and correlation framework 92 is the storage module 94, which is high capacity, high performance distributed storage.

In most utility environments a data repository, data appliance, data warehouse or even a data lake implementation exists. These “operational data stores” offer a significant source of information and can easily be leveraged by the UIP 68. The UIP 68 can be quickly integrated with one or more operational data stores that provides long term storage and other functions such as data cleansing, data quality and data synchronization. The benefit is that data does not need to be replicated inside the UIP 68 for it to be fully utilized. The UIP can easily be integrated with Teradata™, EMC™, IBM™, PI™, Apache™ Hadoop™/Pig™/Hive™/Cascading™ and other solutions.

One the advantages of using the UIP 68 is its ability to rapidly integrate with any system/application within the utility as well as any external systems. This allows the UIP 68 to leverage existing investments and eliminates the need for extensive development during implementation. In many instances, the utility may have an integration technology such as ESB™ and the UIP 68 can easily tie into this to obtain data that is either pushed or pulled. Integration with ESB™ can be through web services or even JMS (Java Message Service).

The UIP 68 has an enterprise mash-up engine that can take information from any number of sources, from anywhere in the utility and effectively integrate, analyze and present the information. The enterprise mash-up concept can be leveraged to create new integrations, obtain new sources of information, aggregate and enrich content and produce new operational intelligence. The UIP 68 platform can rapidly serve up raw and analyzed information in any number of formats. The generally preferred method is via web services (either REST, SOAP or JSON) but can also include files such as CSV or XLS. Web services can be supported over HTTP/HTTPS or even JMS. Where performance might be of concern, JMS can be used for higher throughput and lower overhead. Other formats are also supported including proprietary data feeds as defined by our customers.

The service registry included with the UIP 68 is used to easily manage data sources as well as provide a level of abstraction for development, longevity, documentation, load balancing and redundancy (i.e. definition of multiple sources).

The UIP 68 supports both event-based and pull-models as well as synchronous and asynchronous interfaces. In some cases, it is preferred that events are pushed rather than pulled and this can be effective for near real-time notifications, as needed communications and other event-based solutions.

The UIP 68 leverages the power of information signatures to identify required data elements needed for operations and to rapidly fetch, aggregate, correlate, analyze and fuse information based on the signatures. In some embodiments, an option can be given to allow a user to specify either a freeform search or a search using a query syntax. If a query syntax is used, it uses the signatures for both in-memory and data at-rest queries and inspection. This a core component in the performance of the UIP 68 as the signatures allow extremely fast data inspection and data queries within the complex event processor and across the index. Use of information signatures can identify and track sources of data from file-based, web-based or legacy systems so that even if there is a change of source system, the information signature does not need to be changed.

### D. Methods

While some aspects of the methods have already been covered above, the main methods of the invention are presented here for clarity.

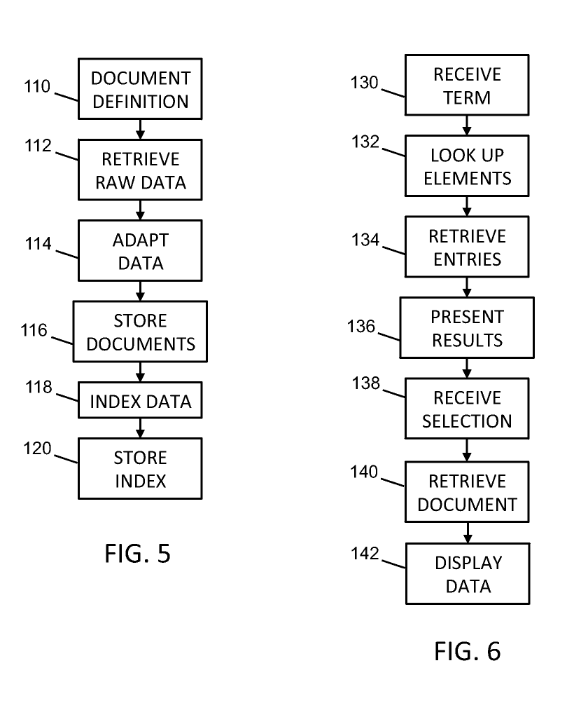

FIG. 5 is a flowchart for the retrieval, storage and indexing of data generated by source systems. In step 110, the SES 40 receives a definition (i.e. schema) of a canonical document 46 to which the data from the source systems 12 is to be adapted. In some embodiments, the canonical document may already exist or there may be templates from which the document can be defined.

In step 112, the SES 40 retrieves data from the source systems 12. This may be on demand, in real time, or in near real time. The data is retrieved in whatever format the source systems supply it in. In step 114, the SES 40 adapts the retrieved data to the canonical documents. Data may be mapped to one or more canonical documents. Data retrieved from the source systems is mapped into canonical documents. The canonical documents are stored in step 116. In step 118, the SES 40 indexes the data in the documents. The index is stored in step 120.

FIG. 6 is a flowchart for searching for data generated by source systems. In step 130, the SES 40 receives a freeform search term from a user, typically a utility network operator. In step 132, the SES 40 searches for the element(s) in the term in the index using a search engine. After the element(s) have been found in the index, the corresponding entry or entries in the index are retrieved by the SES 40, in step 134.

The entries found are then presented, in step 136, to the user who made the request for the search. The SES 40 then, in step 138, receives a selection of an entry from the user, and in response, in step 140, it retrieves the document pointed to by the entry. Data from within the document is then displayed by the SES 40 to the user in step 142.

Alternately, the document(s) may be returned in one step, which is most often the case. In this case, the user is not required to do the second selection at step 138, in which case the process will terminate at step 136, in which the results presented are in fact the document(s) that are retrieved.

### E. Variations

In other embodiments within the purview of the present invention, the SES 40 may be applied to utilities other than electricity supply utilities, and to a combination of multiple utilities. The SES 40 may also be used for the data adaptation, indexing and search in an internet of things.

Steps in the flowcharts may be performed in a different order, other steps may be added, or one or more may be removed without altering the main function of the system. All parameters, and configurations described herein are examples only and actual values of such depend on the specific embodiment.

### F. Industrial Applicability

The SES 40 of the present invention provides an automated, yet adaptable, data collection process that can pull in and integrate data in as close to real time as the capabilities of the underlying source systems permit. The SES 40 can handle as much as 750 million data points daily for every 1 million meters installed on the network, although this is not a limitation as there is no theoretical limit.

The SES 40 is highly scalable to support billions of devices, and can merge data from multiple utility systems. It can perform a high performance search across massive data sets. As well as searching, it can sort and filter data. Mapping aspects of a utility interface platform can also be tied into the SES 40.

### G. Conclusion

The present description is of the best presently contemplated mode of carrying out the subject matter disclosed and claimed herein. The description is made for the purpose of illustrating the general principles of the subject matter and not to be taken in a limiting sense; the subject matter can find usefulness in a variety of implementations without departing from the scope of the disclosure made, as will be apparent to those of skill in the art from an understanding of the principles that underlie the subject matter.

Throughout the description, specific details have been set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense. Therefore, the scope of the invention is to be construed in accordance with the substance defined by the following claims.

1. A processor-implemented method for searching for data generated by multiple source systems in a utility, comprising:
receiving, by the processor, a freeform search term;
searching, by the processor, for one or more elements of the term in an index;
locating, by the processor, one or more entries in the index that correspond to the one or more elements; and
retrieving, by the processor, one or more canonical documents that correspond to the located one or more entries,
wherein the canonical documents comprise the data generated by the multiple source systems in the utility, and
wherein the data generated by the multiple source systems is generated in different formats.

2. The method of claim 1, further comprising:
receiving, by the processor, a schema;
receiving, by the processor, data from multiple source systems;
creating, by the processor, the canonical documents based on the schema;
storing the canonical documents;
indexing, by the processor, at least some of the data in the canonical documents.

3. The method of claim 2, further comprising storing the index in response to the indexing.

4. The method of claim 3, wherein the index indexes over a billion items of data.

5. The method of claim 1, wherein the utility is an electricity utility.

6. The method of claim 1, wherein the multiple source systems comprise at least one smart meter.

7. The method of claim 1, wherein the source systems include one or more of:
a relational database management system;
a NoSQL database;
an application;
an RSS feed; and
a router.

8. The method of claim 2, wherein the receiving of data from the source systems occurs in real time.

9. The method of claim 2, wherein the receiving of data from the source systems occurs in near real time.

10. The method of claim 2, wherein the receiving of data from the source systems occurs in response to a demand initiated by the processor.

11. The method of claim 2, wherein the processor indexes every item of data in the canonical documents.

12. A system for searching for data generated by multiple source systems in a utility, the system comprising:
a processor and;
one or more computer readable media storing:
an index of at least some of the data in a set of canonical documents, wherein the canonical documents comprise the data generated by the multiple source systems in the utility, and wherein the data generated by the multiple source systems is in different formats; and
a search engine that, when executed by the processor, receives a freeform search term and uses one or more elements of said term to locate one or more entries in the index corresponding to said one or more elements.

13. The system of claim 12, wherein the canonical documents are based on a schema.

14. The system of claim 12, wherein the one or more computer readable media stores the canonical documents.

15. The system of claim 12, wherein at least one of the source systems is a smart meter.

16. A computer readable media product comprising computer readable instructions, which, when executed by a processor, cause the processor to:
store an index of data in a set of canonical documents, wherein the canonical documents comprise data generated by multiple source systems in a utility, and wherein the data generated by the multiple source systems is in different formats; and
receive a freeform search term; and
use one or more elements of said term to locate one or more entries in the index corresponding to said one or more elements.

17. The computer readable media product of claim 16 further comprising computer readable instructions, which, when executed by a processor, cause the processor to:
receive a schema for the canonical documents;
receive the data generated by the multiple source systems;
create the canonical documents based on the schema;
store the canonical documents;
index at least some of the data in the canonical documents; and
retrieve one or more canonical documents that correspond to the located one or more entries.
